(19) United States
(12) Patent Application Publication
(10) Pub. No.: US 2023/0404715 A1
(43) Pub. Date: Dec. 21, 2023

(54) DENTAL APPLIANCES FOR TREATING IMPACTED TEETH AND ASSOCIATED SYSTEMS AND METHODS

(71) Applicant: Brius Technologies, Inc., Carrollton, TX (US)

(72) Inventors: Seyed Mehdi Roein Peikar, Carrollton, TX (US); James Sylvester Wratten, Jr., Waterville, NY (US)

(21) Appl. No.: 18/251,689

(22) PCT Filed: Nov. 3, 2021
(86) PCT No.: PCT/US2021/072204

§ 371 Date: May 3, 2023

Related U.S. Application Data
(60) Provisional application No. 63/198,700, filed on Nov. 5, 2020.

(51) Int. Cl. A61C 7/20; A61C 7/16; A61C 7/14

(52) U.S. Cl. CPC A61C 7/20; A61C 7/16; A61C 7/145

(57) ABSTRACT

An orthodontic appliance, an orthodontic device, and associated systems and methods are disclosed herein. In some embodiments, the orthodontic appliance is configured to orthodontically treat an impacted tooth. In some embodiments, the orthodontic device comprises a retention portion configured to be secured to one or more of the patients nonimpacted teeth and an arm extending away from the retention portion. The arm can include a first end portion at the retention portion and a second end portion configured to be positioned adjacent to the impacted tooth. The second end portion of the arm can be configured to indicate a portion of the patient's oral tissue overlying the impacted tooth to be surgically altered. In some embodiments, the second end portion of the arm can be configured to detachably couple to an orthodontic bracket and/or position the orthodontic bracket on or adjacent to an exposed portion of the impacted tooth.

### CROSS-REFERENCE TO RELATED APPLICATION(S)

The present application claims the benefit of priority to U.S. Provisional Patent Application No. 63/198,700, titled DENTAL APPLIANCES FOR TREATING IMPACTED TEETH AND ASSOCIATED SYSTEMS AND METHODS, filed Nov. 5, 2020.

This application is related to the following applications, each of which is hereby incorporated by reference in its entirety: U.S. patent application Ser. No. 16/865,323, titled DENTAL APPLIANCES, SYSTEMS AND METHODS, filed May 2, 2020; International Patent Application No. PCT/US20/31211, titled DENTAL APPLIANCES, SYSTEMS AND METHODS, filed May 2, 2020; U.S. patent application Ser. No. 15/929,443, titled DENTAL APPLIANCES AND ASSOCIATED SYSTEMS AND METHODS OF USE, filed May 2, 2020; U.S. patent application Ser. No. 15/929,444, titled DENTAL APPLIANCES AND ASSOCIATED SYSTEMS AND METHODS OF USE, filed May 2, 2020, U.S. Patent Application No. PCT/US20/70017, titled DENTAL APPLIANCES AND ASSOCIATED SYSTEMS AND METHODS OF USE, filed May 2, 2020; U.S. patent application Ser. No. 15/929,442, titled DENTAL APPLIANCES AND ASSOCIATED METHODS OF MANUFACTURING, filed May 2, 2020, International Application No. PCT/US20/70016, titled DENTAL APPLIANCES AND ASSOCIATED METHODS OF MANUFACTURING, filed May 2, 2020, U.S. Provisional Patent Application No. 62/956,290, filed Jan. 1, 2020, U.S. Provisional Patent Application No. 62/842,391, filed May 2, 2019, and U.S. Provisional Patent Application No. 62/704,545, titled DENTAL APPLIANCES AND ASSOCIATED SYSTEMS AND METHODS OF USE, filed May 15, 2020.

### TECHNICAL FIELD

The present technology relates to dental appliances for treating impacted teeth and associated systems and methods.

### BACKGROUND

A common objective in orthodontics is to move a patient's teeth to positions where the teeth function optimally and aesthetically. To move the teeth, the orthodontist may begin by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, California, USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances.

### SUMMARY

The subject technology is illustrated, for example, according to various aspects described below, including with reference to FIGS. 1A-10. Various examples of aspects of the subject technology are described as numbered clauses (1, 2, 3, etc.) for convenience. These are provided as examples and do not limit the subject technology.

1. An orthodontic device comprising:
a retention portion configured to be temporarily secured to one or more reference teeth of a jaw of a patient; and
an arm comprising a first end portion at the retention portion and a second end portion, wherein, when the retention portion is secured to the one or more reference teeth, the second end portion of the arm is positioned at a location adjacent to an impacted tooth in a mouth of the patient, and wherein the location corresponds to an intended position of a securing member for coupling to an orthodontic appliance configured to treat the impacted tooth.

2. The orthodontic device of Clause 1, wherein the second end portion has a shape corresponding to a shape of a portion of the securing member configured to be bonded to the impacted tooth.

3. The orthodontic device of Clause 1 or Clause 2, wherein the second end portion comprises a coupling member configured to detachably couple to the securing member.

4. The orthodontic device of any one of Clauses 1 to 3, wherein the arm extends from the first end portion to the second end portion along a curved path that facilitates visualization of the second end portion by a human operator when the retention portion is secured to the one or more reference teeth.

5. The orthodontic device of any one of Clauses 1 to 4, wherein, when the retention portion is secured to the one or more reference teeth, the arm extends occlusally away from the retention portion, then curves back in a gingival direction towards the impacted tooth.

6. The orthodontic device of any one of Clauses 1 to 5, wherein the retention portion comprises a shell defining a recess, the recess having a shape substantially conforming to at least a portion of an occlusal surface of the one or more reference teeth.

7. The orthodontic device of any one of Clauses 1 to 6, wherein the retention portion and the arm comprise a monolithic structure.

8. The orthodontic device of any one of Clauses 1 to 7, wherein the retention portion comprises an indicator configured to indicate which teeth of the patient comprise the one or more reference teeth to which the retention portion is configured to be secured.

9. The orthodontic device of any one of Clauses 1 to 8, wherein the impacted tooth is a buccally impacted canine tooth and the location is adjacent to a buccal surface of the buccally impacted canine tooth.

10. The orthodontic device of any one of Clauses 1 to 8, wherein the impacted tooth is a palatally impacted canine tooth and the location is adjacent to a lingual surface of the palatally impacted canine tooth.

11. The orthodontic device of any one of Clauses 1 to 10, wherein the impacted tooth is a first impacted tooth, and the orthodontic device further comprises:
a second arm comprising a first end portion at the retention portion and a second end portion, and
wherein, when the retention portion is secured to the one or more reference teeth, the second end portion of the second arm is positioned at a second location adjacent to a second impacted tooth in the mouth of the patient, and wherein the second location corresponds to an intended position of a second securing member for coupling to an orthodontic appliance configured to treat the first and second impacted teeth.

12. The orthodontic device of any one of Clauses 1 to 11, wherein the retention portion comprises a recess configured to receive a securing member positioned on the one or more reference teeth.

13. An orthodontic device comprising:
a first portion configured to be temporarily secured to one or more reference teeth of a jaw of a patient, and
a second portion cantilevered from the first portion and having a distal end region, the second portion shaped such that, when the first portion is secured to the one or more reference teeth, the distal end region locates a region of the patient's oral tissue overlying a portion of an impacted tooth and intended to be surgically altered to expose the underlying portion of the impacted tooth.

14. The orthodontic device of Clause 13, wherein, when the first portion is positioned on the one or more reference teeth, the distal end region is immediately adjacent or in apposition with the region of the oral tissue.

15. The orthodontic device of Clause 13 or Clause 14, wherein a shape of the distal end region corresponds to a shape of a desired cut in the oral tissue to expose the portion of the impacted tooth.

16. The orthodontic device of any one of Clauses 13 to 15, wherein, when the first portion is secured to the one or more reference teeth, the second portion extends occlusally away from the first portion, then curves back in a gingival direction towards the impacted tooth.

17. The orthodontic device of any one of Clauses 13 to 16, wherein the first and second portions comprise a monolithic structure.

18. The orthodontic device of any one of Clauses 13 to 16, wherein the first and second portions are separate components.

19. The orthodontic device of any one of Clauses 13 to 18, wherein the impacted tooth is a buccally-impacted canine tooth and the region is adjacent to a buccal surface of the buccally-impacted canine tooth.

20. The orthodontic device of any one of Clauses 13 to 18, wherein the impacted tooth is a palatally-impacted canine tooth and the region is adjacent to a lingual surface of the palatally-impacted canine tooth.

21. An orthodontic device comprising:
a retention portion configured to be temporarily secured to one or more reference teeth of a jaw of a patient; and
an arm carried by the retention portion, the arm comprising a proximal end portion at the retention portion and a distal end portion having a coupling region, wherein the coupling region is configured to detachably couple to an orthodontic bracket, and
wherein, when the retention portion is secured to the one or more reference teeth, the arm positions the detachably coupled bracket on or adjacent a portion of an impacted tooth that is exposed through the oral tissue.

22. The orthodontic device of Clause 21, wherein the arm is shaped such that, when the retention portion is secured to the one or more reference teeth, the arm positions the orthodontic bracket at a predetermined orientation relative to the impacted tooth.

23. The orthodontic device of Clause 21 or Clause 22, wherein, when the retention portion is secured to the one or more reference teeth, the arm extends occlusally away from the first portion, then curves back in a gingival direction towards the impacted tooth.

24. The orthodontic device of any one of Clauses 21 to 23, wherein the retention portion and arm comprise a monolithic structure.

25. The orthodontic device of any one of Clauses 21 to 23, wherein the retention portion and arm are separate components.

26. The orthodontic device of any one of Clauses 21 to 25, wherein the impacted tooth is a buccally-impacted canine tooth and the location is a buccal surface of the buccally impacted canine tooth.

27. The orthodontic device of any one of Clauses 21 to 25, wherein the impacted tooth is a palatally-impacted canine tooth and the location is a lingual surface of the palatally-impacted canine tooth.

28. The orthodontic device of any one of Clauses 1 to 27, wherein the oral tissue comprises an oral mucosa.

29. The orthodontic device of any one of Clauses 1 to 28, wherein the oral tissue comprises a gingival tissue.

30. The orthodontic device of any one of Clauses 1 to 28, wherein the oral tissue comprises a palatal tissue.

31. A method comprising:
temporarily securing an orthodontic device to one or more reference teeth of a jaw of a patient, the orthodontic device comprising a first portion configured to engage the one or more reference teeth and a second portion cantilevered from the first portion and having a distal end region; and
positioning the distal end region of the second portion at a location in the patient's mouth, the location corresponding to a position of a portion of an impacted tooth, wherein the portion of the impacted tooth is an intended bonding site for a securing member for coupling to an orthodontic appliance configured to treat the impacted tooth.

32. A method comprising:
temporarily securing an orthodontic device to one or more reference teeth of a jaw of a patient, the orthodontic device comprising a first portion configured to engage the one or more reference teeth and a second portion cantilevered from the first portion and having a distal end region; and
positioning the distal end region of the second portion adjacent the patient's oral tissue at a location overlying a portion of an impacted tooth and intended to be surgically altered to expose the underlying portion of the impacted tooth.

33. The method of Clause 32 further comprising cutting the oral tissue around the distal end region, thereby creating an opening in the oral tissue having a shape corresponding to a shape of the distal end region.

34. The method of Clause 32, further comprising modifying the oral tissue at the location to expose the underlying portion of the impacted tooth.

35. The method of Clause 34, wherein modifying the oral tissue comprises creating a flap at the location.

36. The method of Clause 34, wherein modifying the oral tissue comprises resecting a portion of the patient's oral tissue at the location.

37. A method comprising:
temporarily securing an orthodontic device to one or more reference teeth of a jaw of a patient, the orthodontic device comprising a first portion configured to engage the one or more reference teeth and a second portion cantilevered from the first portion and having a distal end region; and
positioning the distal end region of the second portion adjacent a portion of an impacted tooth that is exposed through the surrounding oral tissue.

38. The method of Clause 37, further comprising detachably coupling a securing member to a coupling region of the distal end region of the orthodontic device.

39. The method of Clause 38, further comprising attaching the securing member to the exposed portion of the impacted tooth while the securing member is detachably coupled to the distal end region of the orthodontic device.

40. The method of any one of Clauses 31 to 39, further comprising removing the orthodontic device from patient's mouth.

41. The method of any one of Clauses 31 to 40, wherein the orthodontic device is a first orthodontic device, and wherein the method further comprises:
temporarily securing a second orthodontic device to one or more reference teeth, the second orthodontic device comprising (a) a retention portion configured to be temporarily secured to the one or more reference teeth of a jaw of the patient, and (b) an arm carried by the retention portion, wherein the arm comprises a proximal end portion at the retention portion and a distal end portion having a coupling region, and wherein the coupling region is detachably coupled to an orthodontic bracket;
while detachably coupled to the coupling region, positioning the orthodontic bracket on a portion of an impacted tooth that is exposed through the surrounding oral tissue;
securing the orthodontic bracket to the portion of the impacted tooth; and
decoupling the orthodontic bracket from the coupling region of the distal end portion of the arm.

42. The method of Clause 41, wherein the first orthodontic device is secured to the same one or more reference teeth as the second orthodontic device.

43. The method of Clause 41 or Clause 42, wherein the first orthodontic device is secured to a different one or more reference teeth as the second orthodontic device.

44. The method of any one of Clauses 41 to 43, wherein the orthodontic bracket is secured to the portion of the impacted tooth via a curable adhesive.

45. The method of any one of Clauses 41 to 44, wherein the orthodontic bracket is secured to the portion of the impacted tooth via application of an energy source.

46. The method of any one of Clauses 31 to 45, wherein the oral tissue comprises an oral mucosa.

47. The method of any one of Clauses 31 to 46, wherein the oral tissue comprises a gingival tissue.

48. The method of any one of Clauses 31 to 46, wherein the oral tissue comprises a palatal tissue.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B schematically illustrate directional references relative to a patient's dentition.

FIG. 2A illustrates a buccally impacted canine tooth in a mouth of a patient.

FIG. 2B illustrates the buccally impacted canine tooth shown in FIG. 2A after the tooth has been surgically exposed.

FIG. 2C illustrates the canine tooth shown in FIGS. 2A and 2B after orthodontic treatment.

FIG. 3 illustrates an orthodontic device configured in accordance with several embodiments of the present technology.

FIG. 4 illustrates an orthodontic device configured in accordance with several embodiments of the present technology, shown secured to a patient's teeth.

FIG. 5 illustrates an orthodontic device configured in accordance with several embodiments of the present technology.

FIG. 6 illustrates an orthodontic device configured in accordance with several embodiments of the present technology, shown secured to a patient's teeth.

FIG. 7 depicts an orthodontic appliance installed within a patient's mouth in accordance with several embodiments of the present technology.

FIGS. 8-10 are plan views of a planar version of various configurations of an orthodontic appliance in accordance with several embodiments of the present technology.

### DETAILED DESCRIPTION

### I. Definitions

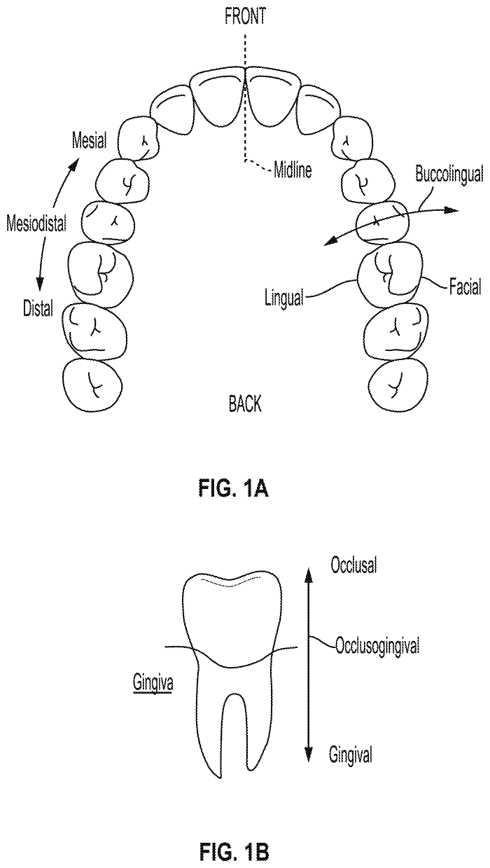

FIGS. 1A and 1B schematically depict several directional terms related to a patient's dentition. Terms used herein to provide anatomical direction or orientation are intended to encompass different orientations of an orthodontic appliance and/or an orthodontic device as installed in the patient's mouth, regardless of whether the structure being described is shown installed in a mouth in the drawings. As illustrated in FIGS. 1A and 1B: “mesial” means in a direction toward the midline of the patient's face along the patient's curved dental arch; “distal” means in a direction away from the midline of the patient's face along the patient's curved dental arch; “occlusal” means in a direction toward the chewing surfaces of the patient's teeth; “gingival” means in a direction toward the patient's gums or gingiva; “facial” means in a direction toward the patient's lips or cheeks (used interchangeably herein with “buccal” and “labial”); “lingual” means in a direction toward the patient's tongue; and “palatal” means in a direction toward the patient's palate. As used herein, the terms “proximal” and “distal” refer to a position that is closer and farther, respectively, from a given reference point. In many cases, the reference point is a certain connector, such as an anchor, and “proximal” and “distal” refer to a position that is closer and farther, respectively, from the reference connector along a line passing through the centroid of the cross-section of the portion of the appliance branching from the reference connector.

As used herein, the terms “generally,” “substantially,” “about,” and similar terms are used as terms of approximation and not as terms of degree, and are intended to account for the inherent variations in measured or calculated values that would be recognized by those of ordinary skill in the art.

As used herein, the term “operator” refers to a clinician, practitioner, technician or any person or machine that designs and/or manufactures an orthodontic appliance or portion thereof, and/or facilitates the design and/or manufacture of the appliance or portion thereof, and/or any person or machine associated with installing the appliance in the patient's mouth and/or any treatment of the patient associated with the appliance.

As used herein, the term “force” refers to the magnitude and/or direction of a force, a torque, or a combination thereof.

### II. Impacted Teeth

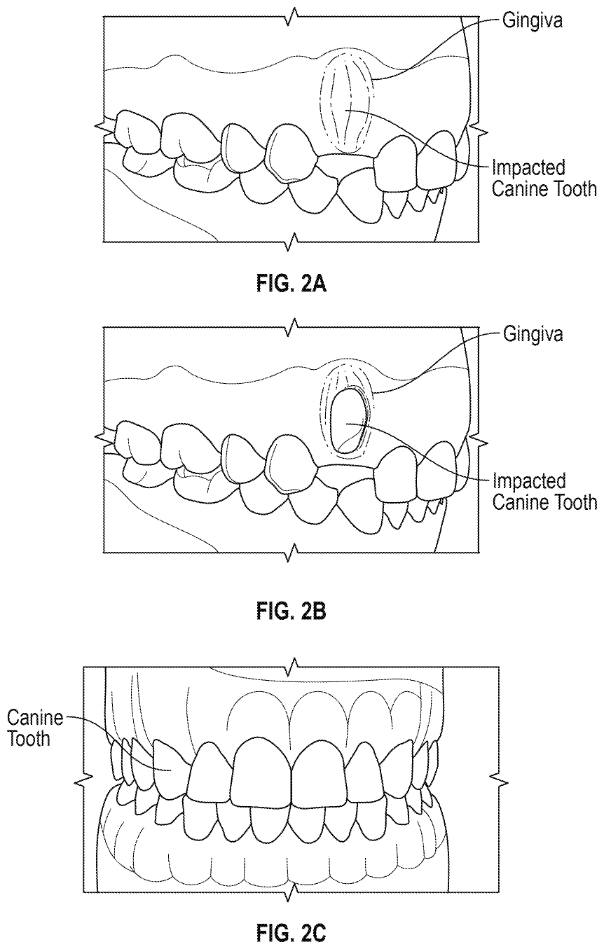

An impacted tooth is a tooth that remains completely or partially embedded in a patient's oral tissue or bone after an expected eruption period for the tooth has passed. Many local, systemic, and genetic etiologic factors are associated with impacted teeth. For example, etiological causes of maxillary canine impaction can include prolonged retention of the deciduous canine, trauma to other deciduous tooth buds, disturbances in tooth eruption sequence, lack of space, rotation of tooth buds, premature root closure, canine eruption into cleft areas, and/or localized pathological lesions such as dentigerous cysts and odontomas. The most commonly impacted teeth are the mandibular third molars, the maxillary third molars, and the maxillary canines, although other teeth such as the maxillary and mandibular premolars and the maxillary central incisors can also be impacted. An impacted tooth can be buccally impacted, palatally impacted, or impacted in the dental arch. For example, FIG. 2A depicts a buccally impacted maxillary canine that is completely embedded within the patient's gingiva. The type oral tissue the impacted tooth is embedded in depends on the location of the tooth and the type of impaction. The oral tissue can comprise an oral mucosa. In some embodiments, the oral tissue comprises the patient's gingiva, palatal tissue, etc.

Impacted teeth can cause a variety of adverse outcomes such as carious lesions, infection, trauma to adjacent teeth, periodontal disease, cysts, and/or tumors. Additionally, impacted teeth, and particularly impacted canines, are associated with poor aesthetics. Some impacted teeth, for example the third molars, are most commonly treated by extracting the impacted tooth. However, surgical extraction of an impacted canine tooth is associated with an undesirable loss of the specialized function and appearance of the canine tooth and often leaves a critical alveolar defect that is difficult to manage. Accordingly, treatment of an impacted canine tooth commonly includes surgically exposing the impacted canine tooth (see FIG. 2B) and orthodontically treating the impacted canine tooth to align the tooth in the dental arch (see FIG. 2C).

To orthodontically treat an impacted tooth, an orthodontic appliance configured to impart forces on and reposition the impacted tooth is installed within the patient's mouth. The impacted tooth is surgically exposed so that at least a portion of the orthodontic appliance can be secured to the exposed surface of the impacted tooth. The portion of the orthodontic appliance secured to the impacted tooth can comprise a securing member such as an orthodontic bracket. In various embodiments, the orthodontic appliance can take any number of forms. As described in further detail herein, in some embodiments, the orthodontic appliance can comprise a deformable member that includes one or more attachment portions, each configured to be secured to a tooth surface directly or indirectly via a securing member, and one or more connectors, each extending directly between attachment portions, between an attachment portion and one or more other connectors, or between two or more other connectors. Additionally or alternatively, the orthodontic appliance can comprise traditional braces, aligners, lingual braces, or other suitable orthodontic appliances.

Typically the orthodontic appliance is configured to be secured to a specific location on the impacted tooth. The specific location may be based wholly or in part on a depth and/or orientation of the impacted tooth within the patient's oral tissue, the forces to be imparted on the tooth during orthodontic treatment, the intended motion of the tooth during orthodontic treatment, etc. Accordingly, surgical exposure involves cutting at least a portion of the patient's oral tissue that is covering the specific location on the impacted tooth. Surgical exposure can involve forming a flap of the portion of the patient's oral tissue and/or resecting the portion of the patient's oral tissue. It is generally desirable to surgically expose only the specific location on the impacted tooth required for securing the orthodontic appliance to reduce unnecessary trauma to the patient's oral tissue. However, it may be challenging to accurately identify the specific location and the appropriate portion of the patient's oral tissue to surgically alter.

### III. Orthodontic Devices

Various embodiments of the present technology comprise orthodontic devices configured to facilitate installation of an orthodontic appliance that is configured to treat an impacted tooth within a patient's mouth. In some embodiments, an orthodontic device is configured to locate a region of the patient's oral tissue overlying a portion of an impacted tooth and intended to be surgically altered to expose the underlying portion of the impacted tooth. In some embodiments, an orthodontic device is configured to position a securing member on a portion of an impacted tooth that is exposed through the oral tissue to facilitate bonding of the securing member to the impacted tooth. A single orthodontic device can be configured to perform one or both above-noted functions. In some embodiments, multiple orthodontic devices configured to perform different functions can be used to facilitate installation of the orthodontic appliance within the patient's mouth.

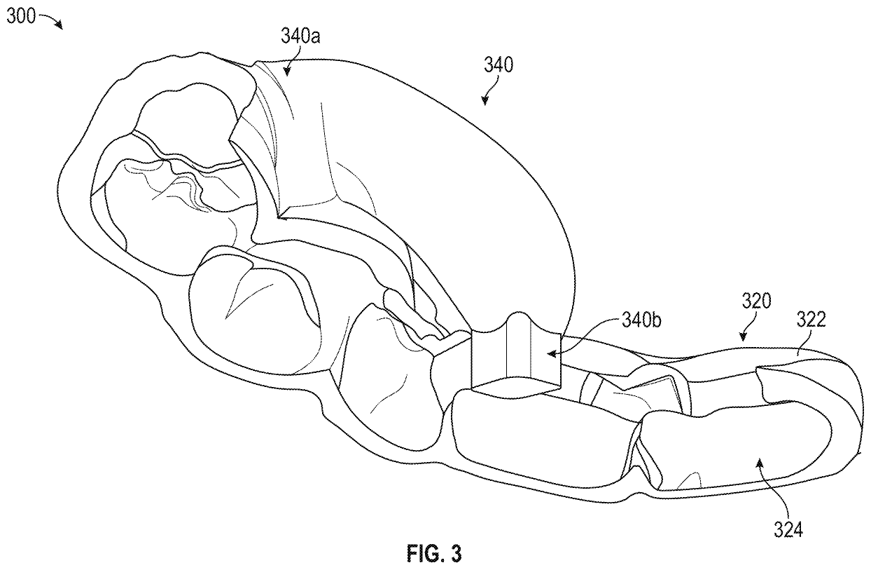

FIG. 3 depicts an orthodontic device 300 (or “device 300”) configured to facilitate installation of an orthodontic appliance configured to treat an impacted tooth. As shown in FIG. 3, the device 300 can comprise a retention portion 320 and an arm 340 extending from the retention portion 320. The retention portion 320 can be configured to be temporarily secured to one or more reference teeth of a jaw of a patient. For example, the retention portion 320 can comprise a shell 322 defining a recess 324 having a shape substantially conforming to all or a portion of a shape of the one or more reference teeth. In some embodiments, the recess 324 has a shape configured to substantially conform to at least an occlusal surface of the one or more reference teeth. In some embodiments, the retention portion 320 may have other suitable configurations, such as one or more bands configured to fit over the one or more reference teeth.

In embodiments in which the retention portion 320 is configured to be secured to a plurality of reference teeth, for example as shown in FIG. 3, the retention portion 320 can comprise a plurality of shells 322, each defining a recess 324 configured to receive all or a portion of a corresponding one of the plurality of reference teeth. In some embodiments, the retention portion 320 comprises one or more indicators configured to indicate which of the one or more reference teeth the retention portion 320 is configured to be secured to. For example, each of the shells 322 can comprise a protrusion in the shape of a letter or number indicating which of the reference teeth the shell 322 is configured to be secured to. The indicator can comprise a protrusion, an embossing, a marking, a coloring, or another suitable visual indicator.

Referring still to FIG. 3, the arm 340 comprises a first end portion 340a at the retention portion 320 and a second end portion 340b opposite the first end portion 340a along a length of the arm. The arm 340 can be cantilevered from the retention portion 320. The second end portion 340b of the arm 340 can be configured to be positioned at a location adjacent to an impacted tooth in the mouth of the patient. The location can correspond to an intended position of a securing member for coupling to an orthodontic appliance configured to treat the impacted tooth.

The arm 340 may be shaped such that, when the device 300 is secured to the one or more reference teeth, the arm 340 takes an indirect path from the retention portion 320 to the targeted location in the mouth. According to some embodiments, for example as shown in FIG. 3, the arm 340 extends along a generally curved path between the first and second end portions 340a, 340b. When the retention portion 320 is secured to the reference teeth, the curved path can facilitate visualization of the second end portion 340b within the patient's mouth by a human operator. In some embodiments, the arm 340 extends away from the retention portion 340 in an occlusal and/or lingual direction before bending back in a gingival direction towards the targeted location. As described in further detail herein, the second end portion 340b of the arm 340 can have a shape substantially corresponding to a shape of a securing member configured to be bonded to an impacted tooth.

Although FIG. 3 depicts a single arm 340, the device 300 can comprise any suitable number of arms. For example, the device 300 can comprise a second arm (not shown) comprising a first end portion at the retention portion 320 and a second end portion. The second end portion of the second arm can be configured to be positioned at a second location adjacent to a second impacted tooth in the mouth of the patient. The second location can correspond to an intended position of a second securing member for coupling to an orthodontic appliance configured to treat the first and second impacted teeth. In some embodiments, the device 300 can comprise one arm 340 per impacted tooth to be orthodontically treated.

The arm 340 and the retention portion 320 can comprise a monolithic structure, as shown in FIG. 3. In some embodiments, the arm 340 and the retention portion 320 comprise separate components that are configured to be coupled together. The position of the arm 340 may be permanently fixed relative to the retention portion 320, or the arm 340 may be moveable relative to the retention portion 320 but still configured to lock in place in a desired position relative to the retention portion 320. The arm 340 and the retention portion 320 can comprise the same material or different materials. For example, the arm 340 can comprise a first material and the retention portion 320 can comprise a second material different than the first material. The device 300 and/or any portion thereof (e.g., the retention portion 320, the arm 340, etc.) may comprise one or more flexible materials including silicone, plastic, polymer, and others. The device 300 can be formed via 3D printing, injection molding, thermoforming, or another suitable technique.

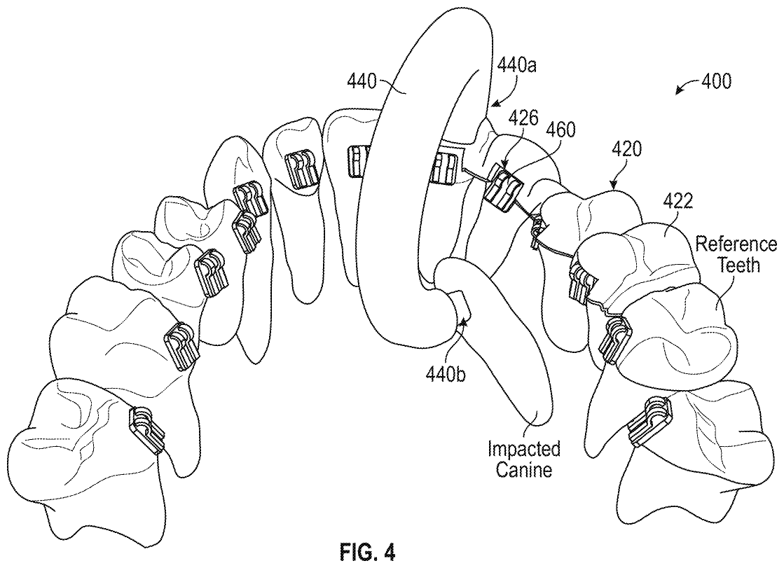

FIG. 4 illustrates an orthodontic device 400 (“device 400”) according to several embodiments of the present technology, shown secured to a plurality of reference teeth of a patient. The device 400 comprises a retention portion 420 configured to be removably secured to the reference teeth and an arm 440 extending from the retention portion 420. As described herein, the retention portion 420 can comprise a plurality of shells 422 defining a plurality of recesses 424, each of the recesses 424 having a shape substantially corresponding to a shape of a corresponding reference tooth. The arm 440 can comprise a first end portion 440a at the retention portion 420 and a second end portion 440b at a position away from the first end portion 440a. In some embodiments, for example as shown in FIG. 4, the arm 440 extends from the first end portion 440a to the second end portion 440b along a curved path. When the retention portion 420 is secured to the reference teeth, the curved path can facilitate visualization of the second end portion 440b within the patient's mouth by a human operator. As shown in FIG. 4, when the retention portion 420 is secured to the reference teeth, the arm 440 can extend occlusally away from the retention portion 420 before curving back in a gingival direction towards the impacted tooth. In some embodiments, for example when the device 400 is configured to treat a palatally impacted tooth, the arm 440 is configured to extend in a lingual direction away from the retention portion 420. In some embodiments, for example when the device 400 is configured to treat a buccally impacted tooth, the arm 440 is configured to extend in a buccal direction away from the retention portion 420.

When the retention portion 420 of the device 400 is secured to the reference teeth, the second end portion 440b of the arm 440 can locate a region of the patient's oral tissue overlying a portion of an impacted tooth and intended to be surgically altered to expose the underlying portion of the impacted tooth. In some embodiments, the region of the patient's oral tissue intended to be surgically altered corresponds to an intended location of a securing member of an orthodontic appliance on the impacted tooth. For example, as shown in FIG. 4, when the retention portion 420 is secured to the reference teeth, the second end portion 440b of the arm 440 can be positioned on or adjacent the oral tissue overlying a lingual surface of a palatally-impacted tooth. In some embodiments, when the retention portion 420 is secured to the reference teeth, the second end portion 440b of the arm 440 can be positioned on or adjacent the oral tissue overlying a buccal surface of a buccally-impacted tooth.

Surgically altering the patient's oral tissue to expose the impacted tooth can comprise cutting, lifting, and/or resecting the oral tissue. In some embodiments, the second end portion 440b comprises a shape corresponding to a shape of a desired cut in the oral tissue to expose the portion of the impacted tooth. The shape of the desired cut may be based, at least in part, on a shape of a securing member to be bonded to the impacted tooth. In use, an operator such as an oral surgeon may cut a portion of the patient's oral tissue adjacent to the second end portion 440b.

In some embodiments, it may be advantageous to surgically expose an impacted tooth after an orthodontic appliance or a portion thereof has been installed within a mouth of the patient. For example, it may be advantageous to create a space in the patient's dental arch for the impacted tooth via a preliminary orthodontic treatment before surgically exposing and orthodontically treating the impacted tooth. Accordingly, as shown in FIG. 4, the retention portion 420 can comprise one or more second recesses 426. Each second recess 426 may be configured to receive at least a portion of a securing member 460 of an orthodontic appliance that has been secured to one of the reference teeth. Additionally or alternatively, the retention portion 420 may be configured to be positioned over the securing member 460. In such embodiments, the corresponding recess 424 of the retention portion 420 may have a shape substantially corresponding to all or a portion of the shape of the corresponding reference tooth with the securing member 460 secured to the reference tooth.

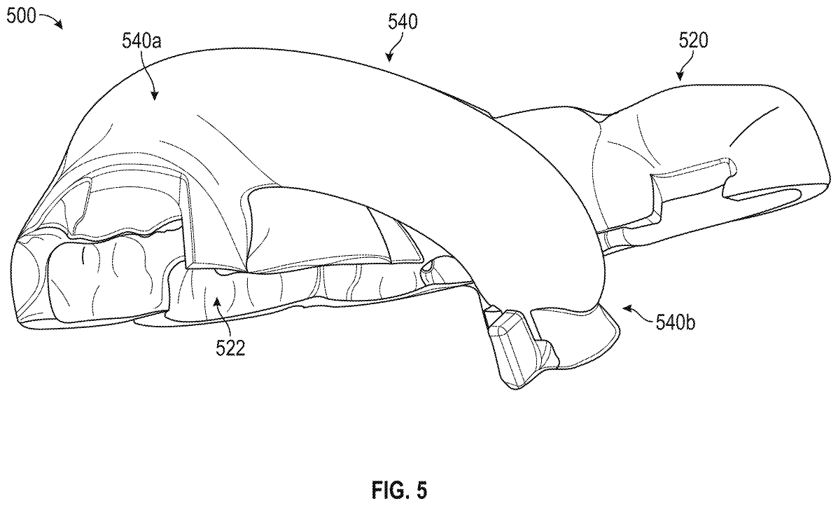

FIG. 5 depicts an orthodontic device 500 (“device 500”) configured to position a securing member of an orthodontic appliance adjacent an impacted tooth in a mouth of a patient, in accordance with several embodiments of the present technology. The device 500 can comprises a retention portion 520 and an arm 540 extending from the retention portion 520. The retention portion 520 can be configured to be secured to one or more reference teeth in a mouth of a patient. For example, the retention portion can comprise a shell 522 defining a recess 524 having a shape substantially corresponding to a shape of all or a portion of one or more reference teeth such that the recess 524 is configured to receive the one or more reference teeth. In embodiments in which the retention portion 520 is configured to be secured to a plurality of reference teeth, for example as shown in FIG. 5, the retention portion 520 can comprise a plurality of shells 522 each defining a recess 524 configured to receive at least a portion of a corresponding one of the reference teeth. In some embodiments, the retention portion 520 comprises one or more indicators configured to indicate which of the one or more reference teeth the retention portion 520 is configured to be secured to. For example, each of the shells 522 can comprise a protrusion in the shape of a letter or number indicating which of the reference teeth the shell 522 is configured to be secured to. The indicator can comprise a protrusion, an embossing, a marking, a coloring, or another suitable visual indicator.

Referring still to FIG. 5, the arm 540 comprises a first end portion 540a at the retention portion 520 and a second end portion 540b opposite the first end portion 540a along a length of the arm. The second end portion 540b of the arm 540 can comprise a coupling region configured to detachably couple to a securing member configured to couple to an orthodontic appliance. The second end portion 540b of the arm 540 can be configured to be positioned at a location adjacent to an impacted tooth in the mouth of the patient such that, when the coupling region is coupled to a securing member, the securing member is configured to be positioned on or adjacent a portion of the impacted tooth. According to some embodiments, for example as shown in FIG. 5, the arm 540 extends along a generally curved path between the first and second end portions 540a, 540b.

Although FIG. 5 depicts a single arm 540, the device 500 can comprise any suitable number of arms. For example, the device 500 can comprise a second arm comprising a first end portion at the retention portion 520 and a second end portion. The second end portion of the second arm can be configured to be positioned at a second location adjacent to a second impacted tooth in the mouth of the patient. The second location can correspond to an intended position of a second securing member for coupling to an orthodontic appliance configured to treat the first and second impacted teeth. In some embodiments, the device 500 can comprise one arm 540 per impacted tooth to be orthodontically treated.

The arm 540 and the retention portion 520 can comprise a monolithic structure, as shown in FIG. 5. In some embodiments, the arm 540 and the retention portion 520 comprise separate components that are configured to be coupled together. The arm 540 and the retention portion 520 can comprise the same material or different materials. For example, the arm 540 can comprise a first material and the retention portion 520 can comprise a second material different than the first material. The device 500 and/or any portion thereof (e.g., the retention portion 520, the arm 540, etc.) may comprise one or more flexible materials including silicone, plastic, polymer, and others. The device 500 can be formed via 3D printing, injection molding, thermoforming, or another suitable technique.

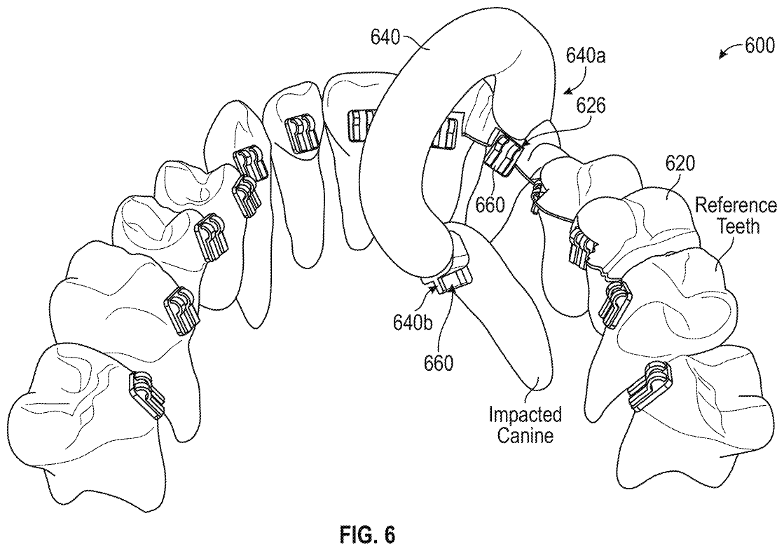

FIG. 6 illustrates an orthodontic device 600 (“device 600”) according to several embodiments of the present technology, shown secured to a plurality of reference teeth of a patient. The device 600 comprises a retention portion 620 configured to be secured to the plurality of reference teeth and an arm 640 extending from the retention portion 620. As described herein, the retention portion 620 can comprise a plurality of shells 622 defining a plurality of recesses 624, each of the recesses 624 having a shape substantially corresponding to a shape of a corresponding reference tooth. In some embodiments, the retention portion 620 comprises one or more second recesses 626 configured to receive at least a portion of a securing member 660 of an orthodontic appliance that has been secured to one of the reference teeth. The arm 640 can comprise a first end portion 440a at the retention portion 620 and a second end portion 640b at a position away from the first end portion 640a. In some embodiments, for example as shown in FIG. 6, the arm 640 extends from the first end portion 640a to the second end portion 640b along a curved path. When the retention portion 620 is secured to the one or more reference teeth, the curved path can facilitate visualization of the second end portion 640b within the patient's mouth by a human operator.

The second end portion 640b of the arm 640 can be configured to receive a securing member 660 of an orthodontic appliance configured to be secured to the impacted tooth. The second end portion 640b can comprise a coupling region configured to detachably couple to the securing member 660. Accordingly, when the retention portion 620 is secured to the one or more reference teeth, the arm 640 can position the detachably coupled securing member 660 on or adjacent a portion of an impacted tooth that is exposed through the oral tissue. The arm can be configured to position the securing member 660 at a predetermined orientation relative to the impacted tooth. Once the retention portion 620 is secured to the one or more reference teeth and the second end portion 640b and the securing member 660 are properly positioned, the securing member 660 can be bonded, adhered, or otherwise secured to the impacted tooth. In some embodiments, the securing member 660 is secured to the impacted tooth via an adhesive and/or a curable material disposed on a surface of the securing member 660 configured to be positioned in contact with the impacted tooth. The curable material can include a composite resin, ceramic, and/or other synthetic material. In some embodiments, the curable material can include dimethacrylate monomers, a filler material (e.g., silica), and/or a photoinitiator that may be activated by UV light (e.g., for bonding). In some embodiments, bonding the securing member 660 to the impacted tooth can comprise exposing the securing member 660, including the curable material disposed on the securing member 660, to an energy source (e.g., UV light). The device 600 can be removed from the patient's mouth with the securing member 660 remaining secured to the impacted tooth. Once the device 600 has been removed such that the securing member 660 remains adhered to the impacted tooth, an orthodontic appliance (as described herein) can be coupled to the securing member 660 to reposition the impacted tooth to a desirable position.

### IV. Orthodontic Appliances

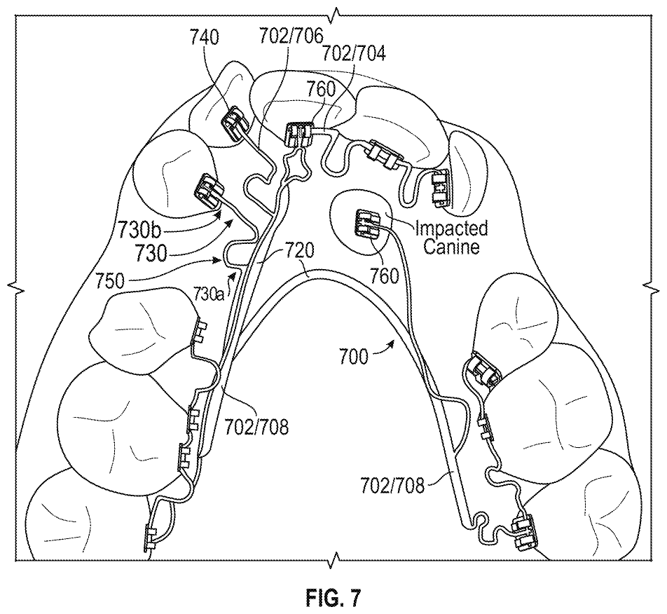

FIG. 7 depicts an orthodontic appliance 700 (“appliance 700”) installed within a patient's mouth in accordance with several examples of the present technology. The appliance 700 is configured to impart forces on at least an impacted tooth of the patient to reposition the impacted tooth. Additionally or alternatively, as shown in FIG. 7, the appliance 700 can be configured to impart forces on at least one nonimpacted tooth of the patient to reposition the nonimpacted tooth. In some cases, the appliance 700 may be configured to maintain a position of one or more teeth. As shown in FIG. 7, the appliance 700 can comprise a deformable member that includes one or more attachment portions 740, each configured to be secured to a tooth surface directly or indirectly via a securing member 760. The appliance 700 may further comprise one or more connectors 702 (also depicted schematically), each extending directly between attachment portions 740 (“first connectors 704”), between an attachment portion 740 and one or more other connectors 702 (“second connectors 706”), or between two or more other connectors 702 (“third connectors 708”). As discussed herein, the number, configuration, and location of the connectors 702 and attachment portions 740 may be selected to provide a desired force on one or more of the teeth when the appliance 700 is installed.

The attachment portions 740 may be configured to be detachably coupled to a securing member 760 that is bonded, adhered, or otherwise secured to a surface of one of the teeth to be moved. As previously described, a securing member 760 can be positioned adjacent the impacted tooth and secured to an exposed surface of the impacted tooth via an orthodontic device. In some embodiments, one or more of the attachment portions 740 may be directly bonded, adhered, or otherwise secured to a corresponding tooth without a securing member or other connection interface at the tooth. The different attachment portions 740 of a given appliance 700 may have the same or different shape, same or different size, and/or same or different configuration. The attachment portions 740 may comprise any of the attachment portions, bracket connectors, and/or male connector elements disclosed in U.S. Patent Publication No. 2017/0156823 A1, which is incorporated by reference herein in its entirety.

The appliance 700 may include any number of attachment portions 740 suitable for securely attaching the appliance 700 to the patient's tooth or teeth in order to achieve a desired movement. In some examples, multiple attachment portions 740 may be attached to a single tooth. The appliance 700 may include an attachment portion for every tooth, fewer attachment portions than teeth, or more attachment portions 700 than teeth. In these and other embodiments, the appliance 700 one or more of the attachment portions 740 may be configured to be coupled to one, two, three, four, five or more connectors 702.

As previously mentioned, the connectors 702 may comprise one or more first connectors 704 that extend directly between attachment portions 740. The one or more first connectors 704 may extend along a generally mesiodistal dimension when the appliance 700 is installed in the patient's mouth. In these and other embodiments, the appliance 700 may include one or more first connectors 704 that extend along a generally occlusogingival and/or buccolingual dimension when the appliance 700 is installed in the patient's mouth. In some embodiments, the appliance 700 does not include any first connectors 704.

Additionally or alternatively, the connectors 702 may comprise one or more second connectors 706 that extend between one or more attachment portions 740 and one or more connectors 702. The one or more second connectors 706 can extend along a generally occlusogingival dimension when the appliance 700 is installed in the patient's mouth. In these and other embodiments, the appliance 700 may include one or more second connectors 706 that extend along a generally mesiodistal and/or buccolingual dimension when the appliance 700 is installed in the patient's mouth. In some embodiments, the appliance 700 does not include any second connectors 706. In such embodiments, the appliance 701 would only include first connectors 704 extending between attachment portions 740. A second connector 706 and the attachment portion 740 to which it is attached may comprise an “arm,” as used herein (such as arm 730 in FIG. 7). In some embodiments, multiple second connectors 706 may extend from the same location along the appliance 700 to the same attachment portion 740. In such cases, the multiple second connectors 706 and the attachment portion 740 together comprise an “arm,” as used herein. The use of two or more connectors to connect two points on the appliance 700 enables application of a greater force (relative to a single connector connecting the same points) without increasing the strain on the individual connectors. Such a configuration is especially beneficial given the spatial constraints of the fixed displacement treatments herein.

Additionally or alternatively, the connectors 702 may comprise one or more third connectors 708 that extend between two or more other connectors 702. The one or more third connectors 708 may extend along a generally mesiodistal dimension when the appliance 700 is installed in the patient's mouth. In these and other embodiments, the appliance 700 may include one or more third connectors 708 that extend along a generally occlusogingival and/or buccolingual dimension when the appliance 700 is installed in the patient's mouth. In some embodiments, the appliance 700 does not include any third connectors 708. One, some, or all of the third connectors 708 may be positioned gingival to one, some, or all of the first connectors 704. In some embodiments, the appliance 700 includes a single third connector 708 that extends along at least two adjacent teeth and provides a common attachment for two or more second connectors 706. In several embodiments, the appliance 700 includes multiple non-contiguous third connectors 708, each extending along at least two adjacent teeth.

In some embodiments, the appliance 700 may be configured such that all or a portion of one, some, or all of the connectors 702 are disposed proximate the patient's gingiva when the appliance 700 is installed within the patient's mouth. For example, one or more third connectors 708 may be configured such that all or a portion of the one or more third connectors 708 is positioned below the patient's gum line and adjacent to but spaced apart from the gingiva. In many cases it may be beneficial to provide a small gap (e.g., 0.5 mm or less) between the third connector(s) 708 and the patient's gingiva, as contact between the third connector(s) 708 (or any portion of the appliance 100) and the gingiva can cause irritation and patient discomfort. In some embodiments, all or a portion of the third connector(s) 708 is configured to be in direct contact with the gingiva when the appliance 700 is disposed in the patient's mouth. Additionally or alternatively, all or a portion of one or more first connectors 704 and/or second connectors 706 may be configured to be disposed proximate the gingiva.

Based on the location of the impacted tooth within the patient's mouth, it may be impractical to position a single third connector 708 adjacent to the patient's gingiva along the entire dental arch. Accordingly, as shown in FIG. 7, the appliance 700 may comprise one third connector 708 configured to be positioned proximate the impacted tooth and another third connector 708 configured to be positioned proximate at least a portion of the patient's dental arch. The appliance 700 may comprise one or more attachment portions 740 that are not coupled to a third connector 708 due to obstruction of a path between the attachment portions 740 and any third connector 708 by the impacted tooth. In such embodiments, for example as shown in FIG. 7, the attachment portions 740 may be coupled to first connectors 704 alone.

According to some embodiments, one or more connectors 702 may extend between an attachment portion 740 or connector 702 and a joint comprising (a) two or more connectors 702, (b) two or more attachment portions 740, or (c) at least one attachment portion 740 and at least one connector 702. According to some embodiments, one or more connectors 702 may extend between a first joint comprising (a) two or more connectors 702, (b) two or more attachment portions 740, or (c) at least one attachment member and at least one connector 702, and a second joint comprising (a) two or more connectors 702, (b) two or more attachment portions 740, or (c) at least one attachment portion 740 and at least one connector 702.

Each of the connectors 702 may be designed to have a desired stiffness so that an individual connector 702 or combination of connectors 702 imparts a desired force on one or more of the teeth. In many cases, the force applied by a given connector 702 may be governed by Hooke's Law, or F=k xx, where F is the restoring force exerted by the connector 702, k is the stiffness coefficient of the connector 702, and x is the displacement. In the most basic example, if a connector 702 does not exist between two points on the appliance 700, then the stiffness coefficient along that path is zero and no forces are applied. In the present case, the individual connectors 702 of the present technology may have varying non-zero stiffness coefficients. For example, one or more of the connectors 702 may be rigid (i.e., the stiffness coefficient is infinite) such that the connector 702 will not flex or bend between its two end points. In some embodiments, one or more of the connectors 702 may be “flexible” (i.e., the stiffness coefficient is non-zero and positive) such that the connector 702 can deform to impart (or absorb) a force on the associated tooth or teeth or other connector 702.

In some embodiments it may be beneficial to include one or more rigid connectors between two or more teeth. A rigid connector 702 is sometimes referred to herein as a “rigid bar” or an “anchor.” Each rigid connector 702 may have sufficient rigidity to hold and maintain its shape and resist bending. The rigidity of the connector 702 can be achieved by selecting a particular shape, width, length, thickness, and/or material. Connectors 702 configured to be relatively rigid may be employed, for example, when the tooth to be connected to the connector 702 or arm is not to be moved (or moved by a limited amount) and can be used for anchorage. Molar teeth, for example, can provide good anchorage as molar teeth have larger roots than most teeth and thus require greater forces to be moved. Moreover, anchoring one or more portions of the appliance 700 to multiple teeth is more secure than anchoring to a single tooth. As another example, a rigid connection may be desired when moving a group of teeth relative to one or more other teeth. Consider, for instance, a case in which the patient has five teeth separated from a single tooth by a gap, and the treatment plan is to close the gap. The best course of treatment is typically to move the one tooth towards the five teeth, and not vice versa. In this case, it may be beneficial to provide one or more rigid connectors between the five teeth. For all of the foregoing reasons and many others, the appliance 700 may include one or more rigid first connectors 704, one or more rigid second connectors 706, and/or one or more rigid third connectors 708.

In these and other embodiments, the appliance 700 may include one or more flexible first connectors 704, one or more flexible second connectors 706, and/or one or more flexible third connectors 708. Each flexible connector 702 may have a particular shape, width, thickness, length, material, and/or other parameters to provide a desired degree of flexibility. According to some embodiments of the present technology, the stiffness of a given connector 702 may be tuned via incorporation of a one or more resiliently flexible biasing portions 750. One, some, or all of the connectors 702 may include one or more biasing portion 750, such as springs, each configured to apply a customized force specific to the tooth to which it is attached.

The biasing portion(s) 750 may extend along all or a portion of a longitudinal axis of the respective connector 702. The direction and magnitude of the force and torque applied on a tooth by a biasing portion 750 depends, at least in part, on the shape, width, thickness, length, material, shape set conditions, and other parameters of the biasing portion 750. As such, one or more aspects of the biasing portion 750 (including the aforementioned parameters) may be varied so that the corresponding arm 730, connector 730, and/or biasing portion 750 produces a desired tooth movement when the appliance 700 is installed in the patient's mouth. Each arm 730 and/or biasing portion 750 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation). For example, the biasing portion 750 of the connector 702 coupled to the impacted canine shown in FIG. 7 may be configured to apply an occlusal force, a buccal force, and/or a distal force to the impacted tooth to move the impacted tooth into alignment with the other teeth.

The biasing portions 750 of the present technology can have any length, width, shape, and/or size sufficient to move the respective tooth towards a desired position. In some embodiments, one, some, or all of the connectors 702 may have one or more inflection points along a respective biasing portion 750. The connectors 702 and/or biasing portions 750 may have a serpentine configuration such that the connector 702 and/or biasing portion 750 doubles back on itself at least one or more times before extending towards the attachment portion 740. For example, in some embodiments the second connectors 706 double back on themselves two times along the biasing portion 750, thereby forming first and second concave regions facing in generally different directions relative to one another. The open loops or overlapping portions of the connector 702 corresponding to the biasing portion 750 may be disposed on either side of a plane bisecting an overall width of the arm 730 and/or connector 702 such that the extra length of the arm 730 and/or connector 702 is accommodated by the space medial and/or distal to the arm 730 and/or connector 702. This allows the arm 730 and/or connector 702 to have a longer length (as compared to a linear arm) to accommodate greater tooth movement, despite the limited space in the occlusal-gingival or vertical dimension between any associated third connector 708 and the location at which the arm 730 attaches to the tooth.

It will be appreciated that the biasing portion 750 may have other shapes or configurations. For example, in some embodiments the connector 702 and/or biasing portion 750 may include one or more linear regions that zig-zag towards the attachment portion 740. One, some, or all of the connectors 702 and/or biasing portions 750 may have only linear segments or regions or may have a combination of curved and linear regions. In some embodiments, one, some, or all of the connectors 702 and/or biasing portions 750 do not include any curved portions.

According to some examples, a single connector 702 may have multiple biasing portions 750 in series along the longitudinal axis of the respective connector 702. In some embodiments, multiple connectors 702 may extend between two points along the same or different paths. In such embodiments, the different connectors 702 may have the same stiffness or different stiffnesses.

In those embodiments where the appliance 700 has two or more connectors 702 with biasing portions 750, some, none, or all of the connectors 702 may have the same or different lengths, the same or different widths, the same or different thicknesses, the same or different shapes, and/or may be made of the same or different materials, amongst other properties. In some embodiments, less than all of the connectors 702 have biasing portions 750. Connectors 702 without biasing portions 750 may, for example, comprise one or more rigid connections between a rigid third connector 708 and the attachment portion 740. In some embodiments, none of the connectors 702 of the appliance 700 have a biasing portion 750.

According to some embodiments, the appliance 700 may include a single, continuous, substantially rigid third connector (referred to as “anchor 720”) and a plurality of flexible arms 730 extending away from the anchor 720. When the appliance 700 is installed in the patient's mouth, each of the arms 730 may connect to a different one of the teeth to be moved and exerts a specific force on its respective tooth, thereby allowing an operator to move each tooth independently. Such a configuration provides a notable improvement over traditional braces in which all of the teeth are connected by a single archwire, such that movement of one tooth can cause unintentional movement of one or more nearby teeth. As discussed in greater detail herein, the independent and customized tooth movement enabled by the appliances of the present technology allows the operator to move the teeth from an original tooth arrangement (“OTA”) to a final tooth arrangement (“FTA”) more efficiently, thereby obviating periodic adjustments, reducing the number of office visits, and reducing or eliminating patient discomfort, and reducing the overall treatment time (i.e., the length of time the appliance is installed in the patient's mouth) by at least 50% relative to the overall treatment time for traditional braces.

The anchor 720 may comprise any structure of any shape and size configured to comfortably fit within the patient's mouth and provide a common support for one or more of the arms 730. In many embodiments, the anchor 720 is disposed proximate the patient's gingiva when the appliance 700 is installed within the patient's mouth. For instance, the appliance may be designed such that, when installed in the patient's mouth, all or a portion of the anchor 720 is positioned below the patient's gum line and adjacent but spaced apart from the gingiva. In many cases it may be beneficial to provide a small gap (e.g., 0.5 mm or less) between the anchor 720 (or any portion of the appliance 700) and the patient's gingiva as contact between the anchor 720 and the gingiva can cause irritation and patient discomfort. In some embodiments, all or a portion of the anchor 720 is configured to be in contact with the gingiva when the appliance 700 is disposed in the patient's mouth.

The anchor 720 may be significantly more rigid than the arms 730 such that the equal and opposite forces experienced by each of the arms 730 when exerting a force on its respective tooth are countered by the rigidity of the anchor 720 and the forces applied by the other arms 730, and do not meaningfully affect the forces on other teeth. As such, the anchor 720 effectively isolates the forces experienced by each arm 730 from the rest of the arms 730, thereby enabling independent tooth movement.

According to some embodiments, the anchor 720 comprises an elongated member having a longitudinal axis and forming an arched shape configured to extend along a patient's jaw when the appliance 700 is installed. In these and other embodiments, the anchor 720 may be shaped and sized to span two or more of the patient's teeth when positioned in the patient's mouth. In some examples, the anchor 720 includes a rigid, linear bar, or may comprise a structure having both linear and curved segments. In these and other embodiments, the anchor 720 may extend laterally across all or a portion of the patient's mouth (e.g., across all or a portion of the palate, across all or a portion of the lower jaw, etc.) and/or in a generally anterior-posterior direction. Moreover, the appliance 700 may comprise a single anchor or multiple anchors. For example, the appliance 700 may comprise multiple, discrete, spaced apart anchors, each having two or more arms 730 extending therefrom. In these and other embodiments, the appliance 700 may include one or more other connectors extending between adjacent arms 730.

Any and all of the features discussed above with respect to anchor 720 may apply to any of the third connectors 708 disclosed herein.

Each of the arms 730 may extend between a proximal or first end portion 730a and a distal or second end portion 730b, and may have a longitudinal axis extending between the first end portion 730a and the second end portion 730b. The first end portion 730a of one, some, or all of the arms 730 may be disposed at the anchor 720. In some embodiments, one, some, or all of the arms 730 are integral with the anchor 720 such that the first end portion 730a of such arms are continuous with the anchor 720. The arms 730 may extend from the anchor 720 at spaced intervals along the longitudinal axis of the anchor 720. In some embodiments, the arms 730 may be spaced at even intervals relative to each other, or at uneven intervals relative to each other, along the longitudinal axis of the anchor 720.

One, some, or all of the arms 730 may include an attachment portion 740 at or near the second end portion 730b. In some embodiments, one or more of the arms 730 is cantilevered from the anchor 720 such that the second end portion 730b of the cantilevered arm(s) 730 has a free distal end portion 730b. In these and other embodiments, a distal terminus of the attachment portion 740 may coincide with a distal terminus of the arm 730. The attachment portion 740 may be configured to detachably couple the respective arm 730 to a securing member (e.g., a bracket) that is bonded, adhered, or otherwise secured to a surface of one of the teeth to be moved. In some embodiments, the attachment portion 740 may be directly bonded, adhered, or otherwise secured to a corresponding tooth without a securing member or other connection interface at the tooth.

Referring to still to FIG. 7, one, some, or all of the arms 730 may include one or more resiliently flexible biasing portions 750, such as springs, each configured to apply a customized force, torque or combination of force and torque specific to the tooth to which it is attached. The biasing portion(s) 750 may extend along all or a portion of the longitudinal axis of the respective arm 730 between the anchor 720 and the attachment portion 740. The direction and magnitude of the force and torque applied on a tooth by a biasing portion 750 depends, at least in part, on the shape, width, thickness, length, material, shape set conditions, and other parameters of the biasing portion 750. As such, one or more aspects of the arm 730 and/or biasing portion 750 (including the aforementioned parameters) may be varied so that the arm 730 and/or biasing portion 750 produce a desired tooth movement when the appliance 700 is installed in the patient's mouth. Each arm 730 and/or biasing portion 750 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

The biasing portions 750 of the present technology can have any length, width, shape, and/or size sufficient to move the respective tooth towards a desired FTA. In some embodiments, one, some, or all of the arms 730 may have one or more inflection points along a respective biasing portion 750. The arms 730 and/or biasing portions 750 may have a serpentine configuration such that the arm 730 and/or biasing portion 750 doubles back on itself at least one or more times before extending towards the attachment portion 740. The arm 730 may double back on itself two times along the biasing portion 750, thereby forming first and second concave regions facing in generally different directions relative to one another. The open loops or overlapping portions of the arm 730 corresponding to the biasing portion 750 may be disposed on either side of a plane bisecting an overall width of the arm 730 such that the extra length of the arm 730 is accommodated by the space medial and/or distal to the arm 730. This allows the arm 730 to have a longer length (as compared to a linear arm) to accommodate greater tooth movement, despite the limited space in the occlusal-gingival or vertical dimension between the anchor 720 and the location at which the arm 730 attaches to the tooth.

It will be appreciated that the biasing portion 750 may have other shapes or configurations. For example, in some embodiments the arm 730 and/or biasing portion 750 may include one or more linear regions that zig-zag towards the attachment portion 740. One, some, or all of the arms 730 and/or biasing portions 750 may have only linear segments or regions, or may have a combination of curved and linear regions. In some embodiments, one, some, or all of the arms 730 and/or biasing portions 750 do not include any curved portions.

According to some examples, a single arm 730 may have multiple biasing portions 750. The multiple biasing portions 750 may be in series along the longitudinal axis of the respective arm 720. In some embodiments, multiple arms 730 may extend in parallel between two points along the same path or along different paths. In such embodiments, the different arms 730 may have the same stiffness or different stiffnesses.

In those embodiments where the appliance 700 has two or more arms 730 with biasing portions 750, some, none, or all of the arms 730 may have the same or different lengths, the same or different widths, the same or different thicknesses, the same or different shapes, and/or may be made of the same or different materials, amongst other properties. In some embodiments, less than all of the arms 730 have biasing portions 750. Arms 730 without biasing portions 750 may, for example, comprise one or more rigid connections between the anchor 720 and the attachment portion 740. In some embodiments, none of the arms 730 of the appliance 700 have a biasing portion 750.

The appliances of the present technology may include any number of arms 730 suitable for repositioning the patient's teeth while taking into account the patient's comfort. Unless explicitly limited to a certain number of arms in the specification, the appliances of the present technology may comprise a single arm, two arms, three arms, five arms, ten arms, sixteen arms, etc. In some examples, one, some, or all of the arms 730 of the appliance may be configured to individually connect to more than one tooth (i.e., a single arm 730 may be configured to couple to two teeth at the same time). In these and other embodiments, the appliance 700 may include two or more arms 730 configured to connect to the same tooth at the same time.

Any portion of the appliances of the present technology may include a biasing portion 750. For example, in some embodiments, portions thereof (e.g., the anchor(s), the arm(s), the biasing portion(s), the attachment portion(s), the link(s), etc.) may comprise one or more superelastic materials.

Additional details related to the individual directional force(s) applied via the biasing portion 750 or, more generally the arm 730, are described in U.S. Patent Publication No. 2017/0156823 A1, the disclosure of which is incorporated by reference herein in its entirety.

The appliances disclosed herein and/or any portion thereof (e.g., the anchor(s), the arm(s), the biasing portion(s), the attachment portion(s), the link(s), etc.) may comprise one or more superelastic materials. The appliances disclosed herein and/or any portion thereof (e.g., the anchor(s), the arm(s), the biasing portion(s), the attachment portion(s), the link(s), etc.) may comprise Nitinol, stainless steel, beta-titanium, cobalt chrome, MP35N, 35N LT, one or more metal alloys, one or more polymers, one or more ceramics, and/or combinations thereof.

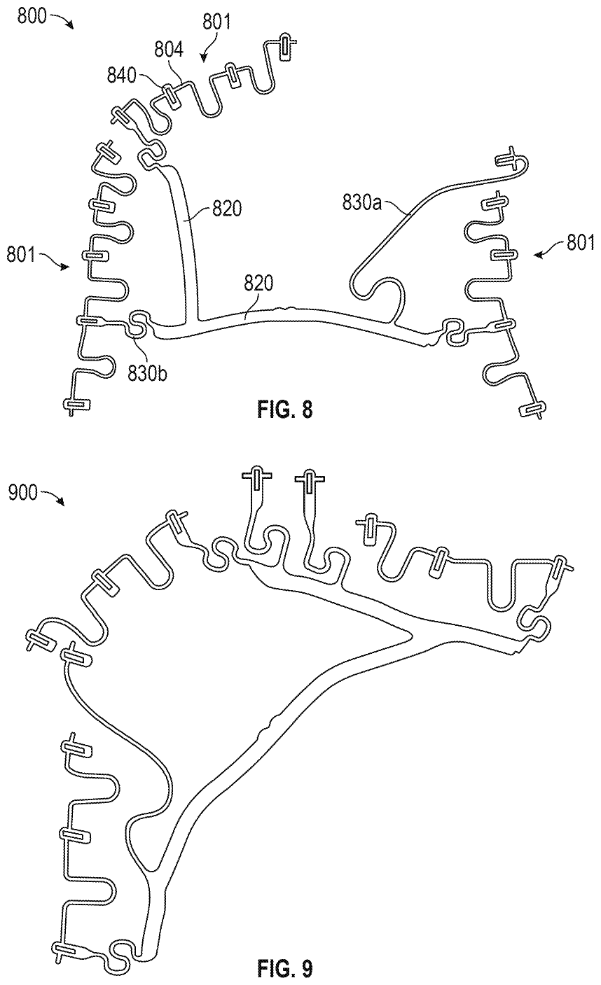

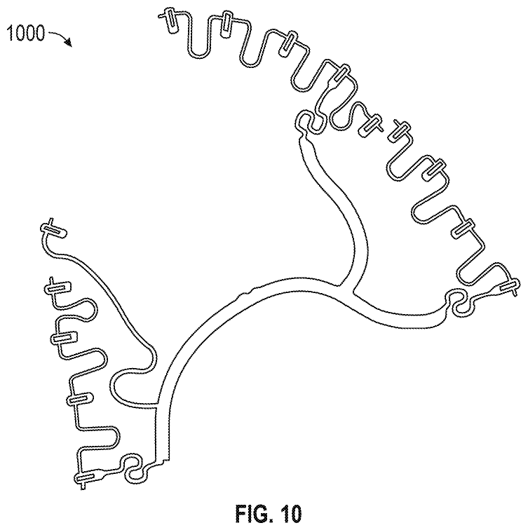

FIGS. 8-10 depict various embodiments of an orthodontic appliance configured to orthodontically treat an impacted tooth. With reference to FIG. 8, an orthodontic appliance 800 configured to treat an impacted tooth may comprise multiple anchors 820 configured to be positioned proximate the patient's gingiva. As the impacted tooth may prevent the anchors 820 from being positioned adjacent the patient's gingiva along the entire dental arch, in some embodiments the orthodontic appliance 800 comprises one or more regions 801 in which attachment portions 840 within the region are not coupled to an anchor 820. Instead, the neighboring attachment portions 840 may be coupled by one or more first connectors 804. In some embodiments, an arm 830a configured to be coupled to an impacted tooth has a greater length than one or more arms 830b configured to be coupled to the nonimpacted teeth, as the impacted tooth may be moved a greater distance during orthodontic treatment. The orthodontic appliances 900, 1000 depicted in FIGS. 9 and 10 illustrate similar concepts.

### CONCLUSION

Although many of the embodiments are described above with respect to systems, devices, and methods for treating impacted teeth, the technology is applicable to other applications and/or other approaches, such as general orthodontics. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-10.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An orthodontic device comprising:
a retention portion configured to be temporarily secured to one or more reference teeth of a jaw of a patient; and
an arm comprising a first end portion at the retention portion and a second end portion, wherein, when the retention portion is secured to the one or more reference teeth, the second end portion of the arm is positioned at a location adjacent to an impacted tooth in a mouth of the patient, and wherein the location corresponds to an intended position of a securing member for coupling to an orthodontic appliance configured to treat the impacted tooth.

2. The orthodontic device of claim 1, wherein the second end portion has a shape corresponding to a shape of a portion of the securing member configured to be bonded to the impacted tooth.

3. The orthodontic device of claim 1, wherein the second end portion comprises a coupling member configured to detachably couple to the securing member.

4. The orthodontic device of claim 1, wherein the arm extends from the first end portion to the second end portion along a curved path that facilitates visualization of the second end portion by a human operator when the retention portion is secured to the one or more reference teeth.

5. The orthodontic device of claim 4, wherein, when the retention portion is secured to the one or more reference teeth, the arm extends occlusally away from the retention portion, then curves back in a gingival direction towards the impacted tooth.

6. The orthodontic device of claim 1, wherein the retention portion comprises a shell defining a recess, the recess having a shape substantially conforming to at least a portion of an occlusal surface of the one or more reference teeth.

7. The orthodontic device of claim 1, wherein the retention portion and the arm comprise a monolithic structure.

8. The orthodontic device of claim 1, wherein the retention portion comprises an indicator configured to indicate which teeth of the patient comprise the one or more reference teeth to which the retention portion is configured to be secured.

9. The orthodontic device of claim 1, wherein the impacted tooth is a first impacted tooth, and the orthodontic device further comprises:
a second arm comprising a first end portion at the retention portion and a second end portion, and
wherein, when the retention portion is secured to the one or more reference teeth, the second end portion of the second arm is positioned at a second location adjacent to a second impacted tooth in the mouth of the patient, and wherein the second location corresponds to an intended position of a second securing member for coupling to an orthodontic appliance configured to treat the first and second impacted teeth.

10. An orthodontic device comprising:
a first portion configured to be temporarily secured to one or more reference teeth of a jaw of a patient, and
a second portion cantilevered from the first portion and having a distal end region, the second portion shaped such that, when the first portion is secured to the one or more reference teeth, the distal end region locates a region of the patient's oral tissue overlying a portion of an impacted tooth and intended to be surgically altered to expose an underlying portion of the impacted tooth.

11. The orthodontic device of claim 10, wherein, when the first portion is positioned on the one or more reference teeth, the distal end region is immediately adjacent or in apposition with the region of the oral tissue.

12. The orthodontic device of claim 10, wherein a shape of the distal end region corresponds to a shape of a desired cut in the oral tissue to expose the portion of the impacted tooth.

13. The orthodontic device of claim 10, wherein, when the first portion is secured to the one or more reference teeth, the second portion extends occlusally away from the first portion, then curves back in a gingival direction towards the impacted tooth.

14. The orthodontic device of claim 10, wherein the first and second portions comprise a monolithic structure.

15. The orthodontic device of claim 10, wherein the impacted tooth is a buccally-impacted canine tooth and the region is adjacent to a buccal surface of the buccally-impacted canine tooth.

16. The orthodontic device of claim 10, wherein the impacted tooth is a palatally-impacted canine tooth and the region is adjacent to a lingual surface of the palatally-impacted canine tooth.

17. An orthodontic device comprising:
a retention portion configured to be temporarily secured to one or more reference teeth of a jaw of a patient; and
an arm carried by the retention portion, the arm comprising a proximal end portion at the retention portion and a distal end portion having a coupling region, wherein the coupling region is configured to detachably couple to an orthodontic bracket, and
wherein, when the retention portion is secured to the one or more reference teeth, the arm positions the detachably coupled bracket on or adjacent a portion of an impacted tooth that is exposed through the oral tissue.

18. The orthodontic device of claim 17, wherein the arm is shaped such that, when the retention portion is secured to the one or more reference teeth, the arm positions the orthodontic bracket at a predetermined orientation relative to the impacted tooth.

19. The orthodontic device of claim 17, wherein, when the retention portion is secured to the one or more reference teeth, the arm extends occlusally away from the proximal end portion, then curves back in a gingival direction towards the impacted tooth.

20. The orthodontic device of claim 17, wherein the oral tissue comprises at least one of an oral mucosa, a gingival tissue, or a palatal tissue.
